(19) United States
(12) Patent Application Publication
(10) Pub. No.: US 2018/0031685 A1
(43) Pub. Date: Feb. 1, 2018

(54) METHOD FOR UNDERWATER SCANNING OF AN OBJECT AND TARGET FOR UNDERWATER SCANNING OF AN OBJECT

(71) Applicant: VRT Finland Oy, JYVASKYLA (FI)

(72) Inventors: Kirsi Hanninen, Kuohu (FI); Olli Auer, Vaajakoski (FI); Matti Savolainen, Tikkakoski (FI)

(21) Appl. No.: 15/552,916

(22) PCT Filed: Mar. 2, 2016
(86) PCT No.: PCT/FI2016/050126

§ 371 Date: Aug. 23, 2017

(30) Foreign Application Priority Data
Mar. 6, 2015 (FI) 20155147

(51) Int. Cl. G01S 7/52; G01S 15/89

(52) U.S. Cl. CPC G01S 7/52004; G01S 15/89

(57) ABSTRACT

A method and corresponding arrangement for improving positioning accuracy of scanning of an underwater object includes equipping the object with at least one floating target having a part above the surface and a part below the surface, determining position data of the target from the part above the surface, scanning the object from under the surface to create measurement observations, detecting the target from the measurement observations under the surface, aligning the position data of the target from the measurement observations with the detected target in order to improve the positioning accuracy of the scanning, determining the target's attitude data time-dependently during the scanning in order to determine the position data of the part of the target below the surface on the basis of the part of the target above the surface, and correcting the alignment of the initial position data of the part of the target below the surface with the measurement observations on the basis of the attitude data.

The invention relates to a method for improving the positioning accuracy of the scanning of an underwater object, in which method
equipping the object to be scanned with at least one target, which includes both a part above the surface of the water and a part below the surface,
determining the position data of the target on the basis of the part above the surface of the water,
determining the initial position data of the part of the target below the surface of the water on the basis of the position data of the target,
scanning the object from under the surface of the water in order to create measurement observations,
identifying the target from the measurement observations under the surface of the water,
aligning the position data of the target from the measurement observations with the identified target in order to improve the positioning accuracy of the scanning.

The invention also relates to an arrangement for the scanning of an object taking place under the surface of the water.

Imaging techniques for underwater objects are known from the prior art, in which imaging devices based on the progression of sound, preferably utilizing laser or ultrasound scanning, scan an underwater object from several different directions. Position data are combined with the images and, using computer software, the images are combined to form a three-dimensional point cloud. A problem, particularly when inspecting structures, is the deficient positioning accuracy of the scanning, which makes it difficult to find damage areas in the structure being inspected, for example, a bridge. The position data of measurement observations are usually based on the position data of the scanning unit, for example a scanning boat, which can be deficient. For example, when operating under a bridge the positioning of the scanning boat is in a shadow, so that the precise position data of the scanning boat cannot be defined.

From the prior art laser scanners are also known, by means of which images can be taken of underwater objects, for example, from an aircraft. However, the investment costs of such devices are extremely high. In addition, laser scanning does not work in areas of deep or turbid water.

Also known from the prior art is publication WO 2012/101423 A2, which discloses the use of acoustic targets in positioning objects. A problem with an acoustic target is, however, that its precise position data are not known when it is submerged under water.

Further known from the prior art is Michael Esten Dix's publication Accuracy Evaluation of Terrestrial Lidar and Multibeam Sonar Systems Mounted on a Survey Vessel. The publication discloses the scanning of a waterway, in which a target is used that is locked permanently to the object, and which extends both above and below the water surface. However, in this method a fixed target is used, which should be attached to the object being imaged, so that the parts of the target above and below the water surface will receive the same position data. The installation of the target is then precise.

The invention is intended to create a method for scanning an object under water, with the aid of which method the positioning accuracy of an underwater object can be improved. The characteristic features of this invention are stated in the accompanying claim 1. The invention is also intended to create an arrangement for the scanning of an object that takes place under the water surface, which arrangement improves the positioning accuracy of the scanning of an underwater object. The characteristic features of this invention are stated in the accompanying claim 8.

The intention of the method according to the invention can be achieved by means of a method for scanning an object under water, in which method the object to be scanned is equipped with at least one floating target, which includes both a part above the water surface and a part below the water surface, the target's position data being determined on the basis of the part above the water surface, the target's attitude data is determined time-dependently during scanning in order to determine the initial position data of the target's part below the surface of the water on the basis of the part of the target above the water surface, and the target is scanned from under the water surface in order to create measurement observations. In addition, in the method the target is detected from the underwater measurement observations, the target's position data is aligned with the target detected from the measurement observations in order to improve the positioning accuracy of the scanning and the alignment of the initial position data of the part of the target below the water surface with the measurement observations is corrected on the basis of the attitude data.

By using the part of the target above the water surface for the positioning of the target, the target's position data can be determined extremely accurately and quite simply. If the target's attitude data is also taken into account at this stage, the deviation between the floating target's part above the water surface and the part below the water surface can be determined time-dependently for each measurement observation. The deviation is due to the change in the attitude of the floating target. With the aid of the precise position data of the part of the target below the water surface, the measurement observations can also be aligned with considerable precision with the aid of the target deviating from the measurement observations, which improves the applicability of the results of the measurement, for example in structural inspections. In this connection, reference to the initial position data of the part of the target below the surface of the water means the position data of the part below the surface that have not yet been corrected with the aid of the attitude data of the target to form accurate position data of the part of the target below the surface of the water.

In the method according to the invention, the apparatus used for the positioning of the target is preferably a different apparatus to the scanning means. The positioning of the target can then be performed more accurately than by using the scanning means.

The correction of the alignment of the position data of the target to the measurement observations refers to the fact that the position data of the part of the target under the water surface are formed from the position data of the part of the target above the water surface by taking into account the target's attitude data, on the basis of which by exploiting the known dimensions of the target it is possible to calculate the position data of the part of the target below the water surface from the initial position data.

The underwater object is preferably scanned using echo-sounding technology. Echo sounding is reliable in operation and sufficiently accurate for the scanning of objects.

According to another embodiment, the underwater object is scanned using laser-scanning means. Laser-scanning means operate analogously to echo-sounding means in that a beam is first sent and the beam or echo reflected back from the object being scanned is measured.

According to one embodiment, the precise position of the target is determined with the aid of satellite positioning using the part of the target above the water surface. The target's position data can then be combined directly with the attitude data simply and rapidly without separate intermediate stages.

According to another embodiment, the precise position of the target is determined optically with the aid of a tachymeter using the part of the target above the water surface. Using a tachymeter gives extremely accurate positioning data, the error being only in the order of millimetres. In addition, determining the position data of the target by means of a tachymeter takes place from the side, so that, for example, bridges or similar do not prevent the determining of position.

If the position data of the target is determined optically with the aid of a tachymeter, satellite positioning or, for example, the known position data of some object, can be used to define the position of the tachymeter.

In the method, the angle of tilt is preferably defined as the attitude data. Thus, the attitude of the target can be defined precisely, so that the deviation of target marks attached to the body relative to the central attitude can be defined precisely.

In the method, the direction of tilt is also preferably defined as the attitude data. This increases the precision of the method.

According to one embodiment, the angle and direction of tilt can be determined with the aid of an acceleration sensor and an angle sensor, the direction of tilt of the target being defined with the aid of the acceleration sensor, and the magnitude of tilt with the aid of the angle sensor. Such an embodiment is particularly accurate.

According to a second embodiment, the angle and direction of tilt can be determined with the aid of two satellite-positioning means, with the aid of each of which satellite-positioning means the tilt of the target and its direction can be determined. Such determining is, however more expensive to implement than with an acceleration and angle sensor and is less accurate in measurement.

According to a third embodiment, the angle and direction of tilt can be determined optically with the aid of a tachymeter and at least two prisms. In this case, the prisms are located on the body of the target and, on the basis of their and the tachymeter's known positions the attitude of the target can be determined. Such a determining of the attitude demands, however, a direct line of vision to the target, which may be a problem if the tachymeters are situated on the shore.

The attitude data can be defined at a frequency that is 30 400 Hz, preferably 60-200 Hz. Sufficient data on the movements and attitudes of the target can then be obtained even in a rough sea.

The term combining the time-dependent attitude data with the position data refers to the fact that a time datum is also combined with each position datum. Thus the position data and attitude data of the target appearing in the measurement observations are known at each moment in time.

The part of the target under the water surface is preferably detected from the measurement observations and the position data of the measurement observations are used to combine the consecutive measurement observations to form a point cloud. The detection of the target from the measurement observations gives all of the measurement observations a precise position datum.

According to one embodiment, the consecutive measurement observations are combined on the basis of the position datum to for a point cloud. In the point cloud, the measurement observations both above the water surface and below the water surface can be combined to form a unified, preferably three-dimensional model.

In scanning, a scanning unit can be used, which moves at a speed of 0.1-2.5 m/s, preferably 0.8-1.5 m/s during scanning. A sufficiently low speed of progression permits a sufficiently high observation density (scanning frequency) for the surface area, when there will be an image of an individual detail of the object being scanned in several measurement observations. This in turn increases the accuracy of the scanning considerably.

Preferably the positioning data of the target and the time are determined simultaneously. The position of the target will then be known time-dependently.

The position data is preferably time-stamped automatically. Information will then be attached to each position datum as to when the position datum was determined.

The attitude data of the target is preferably determined in real time. By being determined in real time, the measurement moment of the position data of the underwater target will be known exactly, and, when the object is scanned, it can be immediately ensured that the data has a precise position. If the data does not have a precise position, measures can be taken at once to seek the fault, so that when leaving the object being scanned reliable measurement data will have been obtained.

In connection with the real-time attitude data, the second position data determined on the basis of the underwater part are preferably corrected using the target's said attitude data to create corrected second position data and to compare the corrected second positioning data with the first position data determined on the basis of the part above the water surface, in order to improve the accuracy of the scanning.

Alternatively, the attitude data can be determined by post-calculation, but in that case the positioning accuracy will be ensured only when processing the imaging data, having left the imaging location. On the other hand, a greater accuracy can be achieved by post-calculation than by real-time determining.

According to one embodiment, the part of the object above water is also scanned using photographic apparatus and the photographs are combined with the point cloud to create a total visual model of the object. In this case, the part of the target above the water surface greatly facilitates the alignment of the scanning data above and below the water surface with each other.

According to one embodiment, the positioning data of the scanning unit above the water surface can be determined relatively with the aid of the target, if the target is equipped, for example, with a tachymeter and positioning means and the scanning unit with a prism.

In this connection it should be understood that the determining of the position data can also be the determining of relative position data instead of the determining of absolute position data, in which case the position data of the target is determined relative to the position data of the scanning unit, if the position data of the target is not determined absolutely, for example with the aid of satellite positioning. Alternatively, the positioning data of the scanning unit can also be determined with the aid of the target.

The intention of the arrangement according to the invention can be achieved by means of an arrangement for scanning an object taking place under water, which arrangement includes a floating target, positioning means for determining positioning data of the target, and attitude detection means for detecting the attitude of the target time-dependently. The target includes a body, attachment means joined to the body for securing the target in place in a desired location in the vicinity of the object, a target mark under the water surface joined in connection with the body for distinguishing the target, and a target mark above the water surface joined in connection with the body for determining the precise position of the target. The target's target mark under the water surface acts as a fixed point known in echo-sounding while the target mark above the water surface acts, in turn, as a locatable object. Thus, the known fixed point of the measurement observations can be linked to precise position data, which are used to align the measurement observations. With the aid of the target's attitude detection means, the deviation between the target's target mark above the water surface and the target mark below the water surface can be determined while the target floats and thus the overall accuracy of the scanning improves considerably. The floating target can be situated separately from the object being scanned, so that there is no obstacle to the scanning of the object. In addition, the floating target need not be attached to the object being scanned, for example by drilling.

In this connection, the use of the term floating target refers to the fact that that target floats on water and at least two of its directions of movement are free. This means that the target can be attached to the object with the aid of a certain pivot arm, but the target is floating and free to move in at least two directions of movement.

In the arrangement, the target is preferably separate from the object being scanned, so that it need not be physically attached to the object.

According to one embodiment, the attitude-detection means are situated in the target in order to detect the target's attitude. The detection means can then be, for example, satellite-positioning means, such as GPS or similar. Such positioning means are simple and quick to use.

According to one embodiment, the attitude-detection means are an acceleration sensor and an angle sensor. With their aid the attitude of the target can be determined directly in connection with the target quickly and accurately.

The target's body is preferably floating and thus the entire target floats.

The arrangement can include a scanning unit for scanning the target, which includes second positioning means for positioning the scanning unit. With the aid of the target, either the position of the target, or alternatively also the position of the scanning unit can be determined, if the position of the target is known.

According to a second embodiment, the attitude-detection means are optical detection means, preferably a tachymeter. By means of optical positioning means the object can be defined extremely accurately. The optical detection means can be located separately from the target, for example in the scanning unit or on the shore.

According to a third embodiment, the attitude-detection means are two satellite positioning devices. With their aid, the attitude of the target can be determined by determining the position data of two different points on the target, on the basis of which the attitude of the target can be deduced.

According to one embodiment, the positioning means are a satellite-positioning device fitted to the target. With the aid of the satellite-positioning device, the position data of the target can be determined easily and quickly.

The arrangement preferably also includes a computer for recording the target's position data and the target's attitude-detection means are arranged to transmit the attitude data in real time using the satellite-positioning device to the computer. Thus the accuracy of the data can be checked in real time using the computer, in which the echo-sounding means' observations preferably belonging to the arrangement are also recorded.

According to another embodiment, the positioning means belonging to the arrangement are a tachymeter separate from the target and a prism attached to the target. With the aid of the use of the tachymeter and prism the position data can be determined with great precision.

According to one embodiment, the attitude-detection means include memory means for attaching the momentary attitude to the time data and recording them. The attitude of the target can then also be determined in post-processing.

According to one embodiment, the target's attachment means can be an arm. With the aid of the arm, the target can be attached, for example, directly to a jetty or other floating object. By means of the fixed attachment, a very stable location is achieved for the target.

According to another embodiment, the attachment means can be an anchor. With the aid of the anchor, the floating target can be locked in place in the vicinity of the object to be scanned.

The target mark below the water surface preferably comprises shaped object-surface shapes for facilitating observation of the target mark below the water surface. With the aid of the object-surface shapes, the target can be easily distinguished from the measurement observations.

The attitude-detection means can also include a gyro, i.e. compass, for determining the direction of the target. The target's direction can also be deduced with the aid of the gyro.

If scanning of the parts under the water surface is used together with imaging of the part above the water surface, the alignment of the visual models of the parts above and below the water surface with the aid of the target will be more accurate and faster, as well as permitting automation of the combination of the models. The use of target also increases the reliability and traceability of the data.

By means of the method according to the invention, more precise positioning accuracy is achieved than by method of the prior art, as the position data and attitude data appearing in the measurement observations are defined precisely on the basis of the part of the target above the water surface. Using the method achieves RTK accuracy already in the measurement stage. The method can also be used to make precise measurements in areas that are outside the signal of satellite positioning, such as, for example, beneath large bridges, or close to trees. The target can then be detected optically, or the target can be located in the transmission range of the satellite-positioning signal, so that the target is nevertheless visible in the measurement observations.

According to one embodiment, the target includes a tachymeter and satellite-positioning device, with the aid of which the positioning data of, for example, echo-sounding means in a boat, can be determined. Such an embodiment may be necessary, if the boat is, for example, in a shadow under a bridge.

In the present application, the terms location and position data mean the same thing.

In the following, the invention is examined in detail with reference to the accompanying drawings depicting some embodiments of the invention, in which

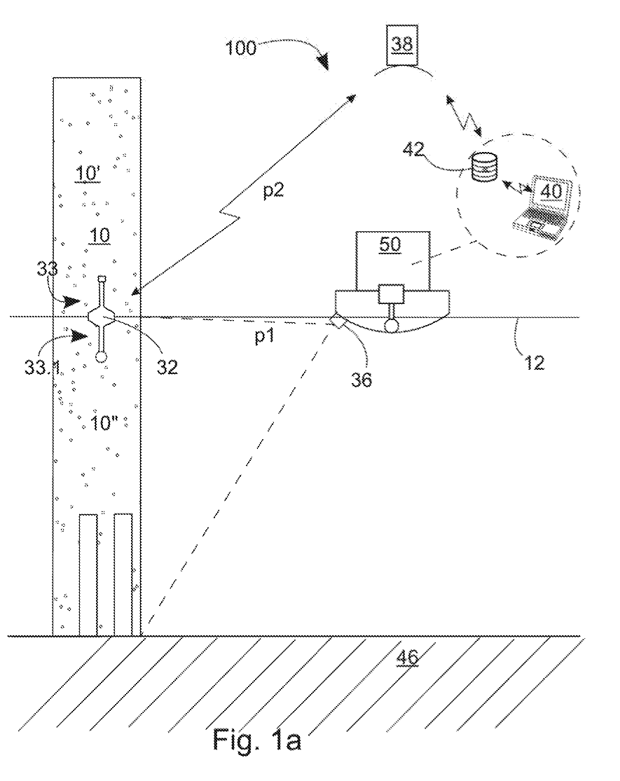

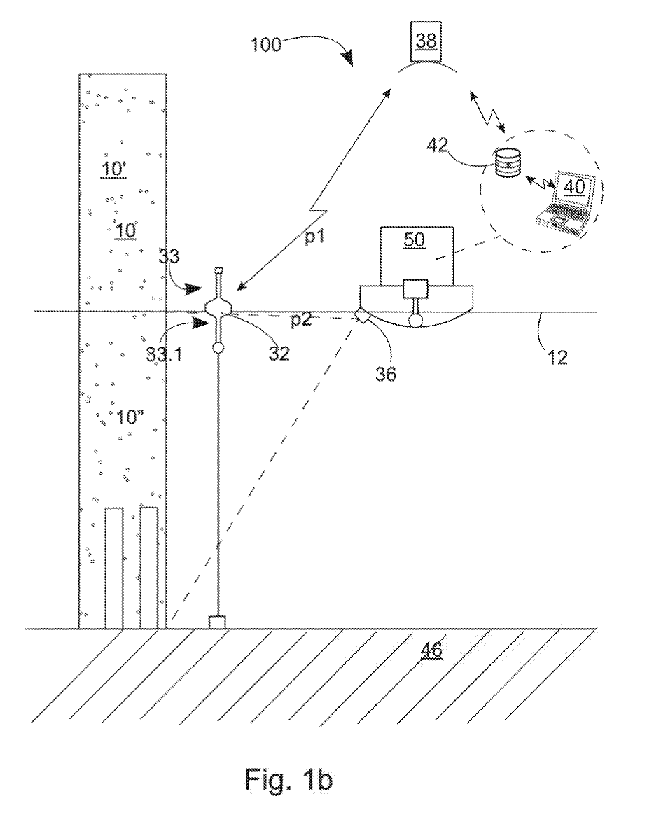

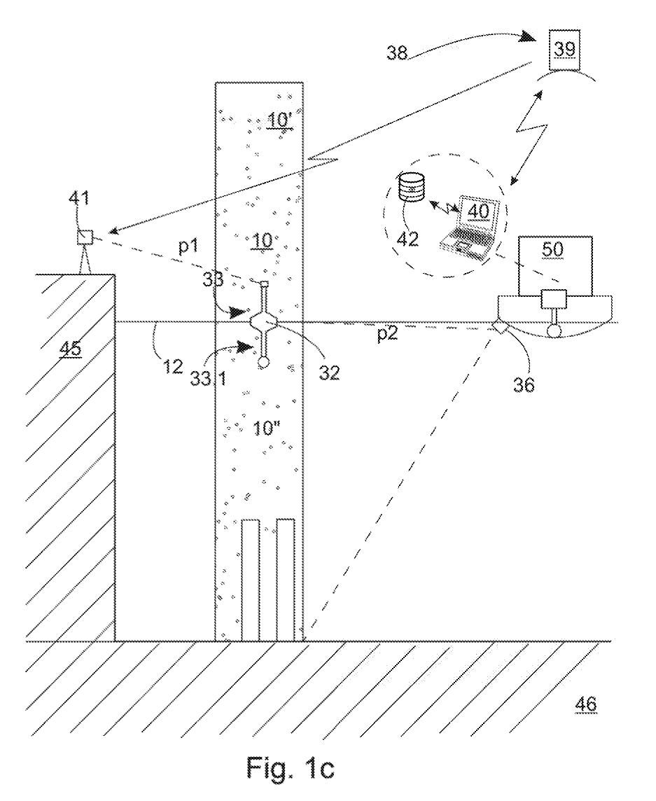

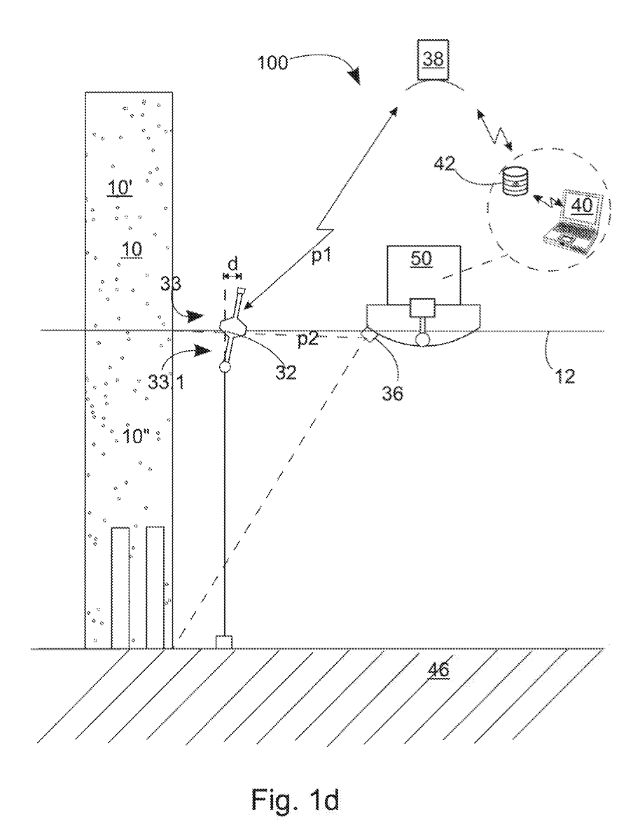

FIG. 1a shows a schematic side view of a first embodiment of the method according to the invention,

FIG. 1b shows a schematic side view of a second embodiment of the method according to the invention,

FIG. 1c shows a schematic side view of a third embodiment of the method according to the invention,

FIG. 1d shows a schematic side view of the second embodiment of the method according to the invention, when the target is tilted,

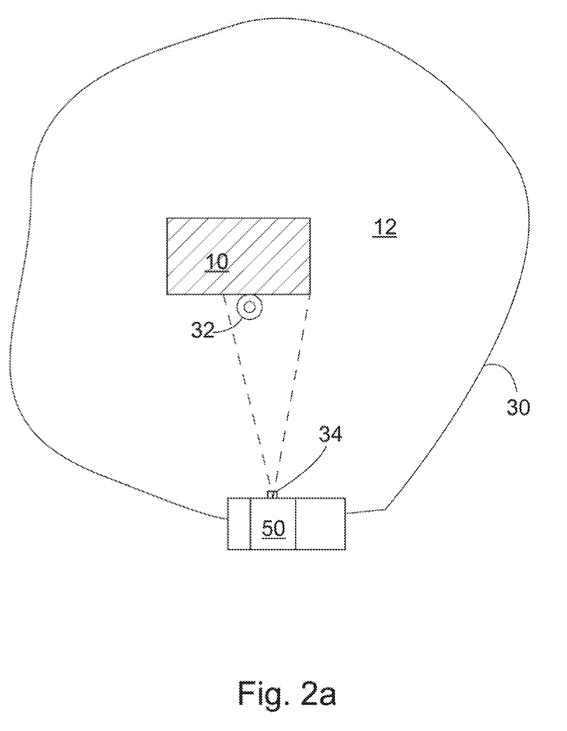

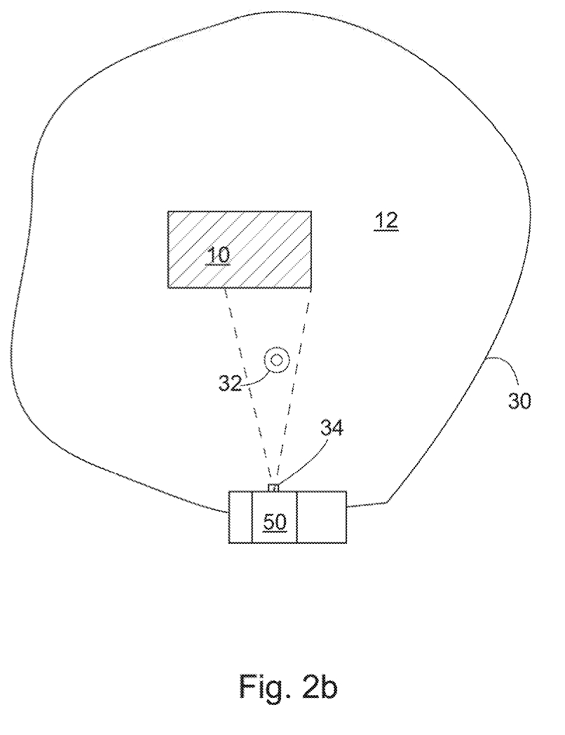

FIG. 2a shows a schematic top view of the embodiment of FIG. 1a,

FIG. 2b shows a schematic top view of the embodiment of FIG. 1b,

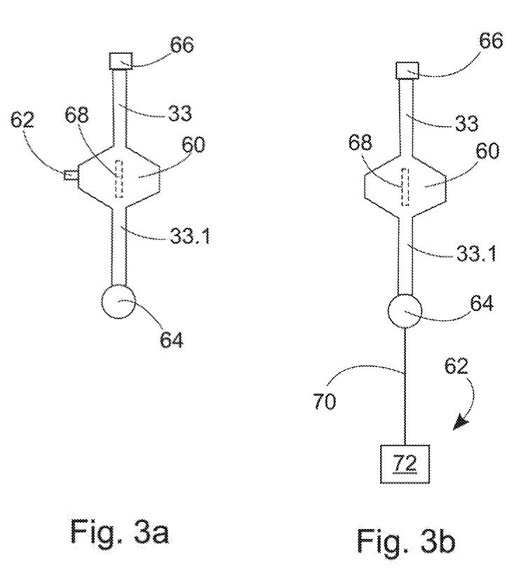

FIG. 3a shows a schematic side view of a first embodiment of the target of an arrangement according to the invention,

FIG. 3b shows a schematic side view of a second embodiment of the target of an arrangement according to the invention,

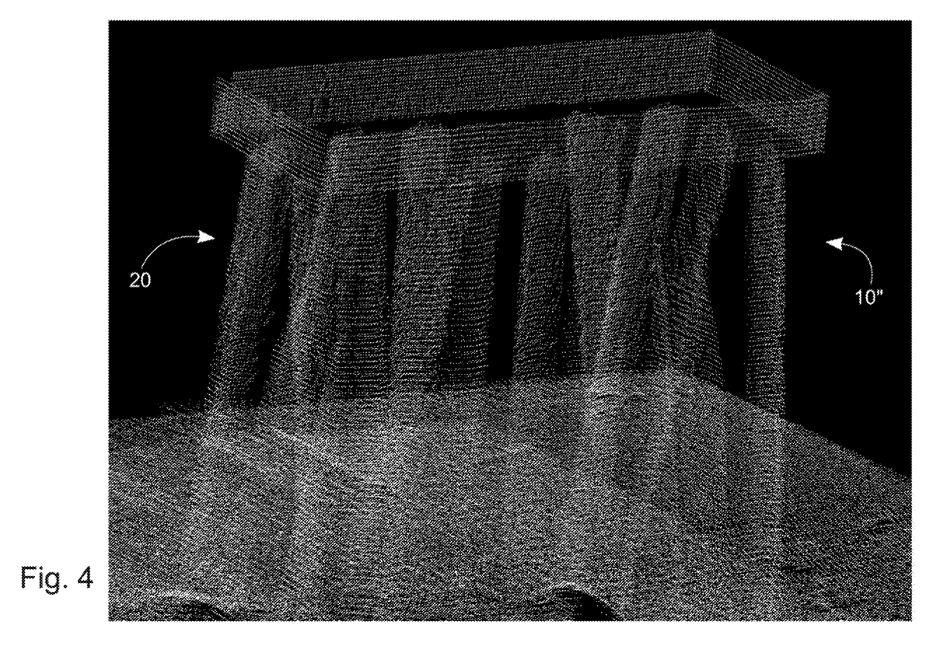

FIG. 4 shows an axonometric view of a three-dimensional point cloud of the part under water of an object being scanned

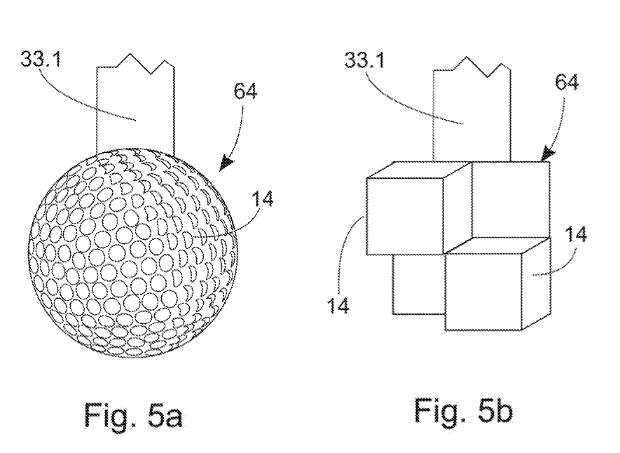

FIG. 5a shows a schematic view of a first embodiment of the underwater target mark of the target,

FIG. 5b shows a schematic view of a second embodiment of the underwater target mark of the target.

FIGS. 1a-1c show three embodiments of an apparatus suitable for implementing the method and arrangement according to the invention, in each of which embodiment the apparatus includes echo-sounding means 36 arranged in a scanning unit 50, for example, a boat, for scanning an object 10 from several different directions under the surface 12 of the water, and at least one target 32 situated in connection with the object 10 being scanned. In addition, the apparatus includes positioning means 38 for combining the position data of the target 32 and preferably also the direction of the echo-sounding means 36 with each measurement observation created using the echo-sounding means 36, as well as a computer 40 comprising software means 42. In this connection, the object 10 being scanned can be, for example, a support pillar of a bridge according to FIGS. 1a-2b, which has a part 10′ above the water surface 12 and a part 10″ under the water surface 12. The computer used can be, for example, a normal laptop computer. The target 32 preferably includes a part 33 above the water surface 12 and a part 33.1 below the water surface 12.

The echo-sounding means 36 can be, in turn, attached to the boat acting as the scanning unit 50 or to some other base moving under the water surface 12, from which the echo-sounding means 36 used as the scanning means have preferably a direct and unobstructed connection to the object being scanned. Alternatively, the echo-sounding means can also be situated at one point, so that only their orientation is changed during scanning. In addition to a boat, other moving bases can be aircraft, helicopters, water scooters, ships, and boats. The term echo-sounding means refers to measurement devices based on the progression of sound, for example, ultrasound devices. The echo-sounding means can be preferably aimed at the object being scanned. In connection with the description of the figures, echo-sounding means act as the scanning means, but it should be understood that the scanning means can also be laser-scanning means.

The positioning means 38 used in the method for positioning the target can be, for example, a GPS positioning device receiving it position from a satellite 39, as in FIGS. 1a and 1b, or an optical measurement device 16, such as the tachymeter of FIG. 1c, in which position definition takes place, for example, by GPS positioning. Instead of GPS positioning, satellite positioning such as GNNS positioning can generally be used.

In the method according to the invention, scanning takes place in such a way that initially the object 10 being scanned is equipped with at least one floating target 32, which can be attached to the object to be scanned according to the embodiments of FIGS. 1a and 1c, or which is preferably attached in the vicinity of the object 10 to be scanned according to the embodiment of FIG. 1b. After this, in the embodiment of the figures, with the aid of the echo-sounding means 36 attached to the boat acting as the scanning unit 50, the object 10 selected is scanned by going round the object 10 along the routes 30 shown in FIGS. 2a and 2b. In principle, the method can even be used to align an individual measurement observation, but preferably there are several scanning runs and measurement observations obtained from the scanning runs and the object being scanned is scanned at least once, preferably two or three times, or driving parallel to the object (for example, along the jetty line). The echo-sounding means 36 measure the echo returning from the object at a preselected frequency, which depends on the speed of movement of the echo-sounding means relative to the object 10 being scanned. The speed of the boat or other scanning base can be 0.1-2.5, preferably 0.8-1.5 m/s, which is a sufficiently low speed for scanning the object with sufficient precision using existing echo-sounding technology. In the future, the speed of the scanning base can possibly be raised, if the frequency and operating speed used in echo-sounding technique increase.

Using existing apparatus, the scanning frequency of the echo-sounding means can be a maximum of 60 Hz and the scanning frequency is preferably 10-60 Hz. In this connection, the term scanning frequency is also referred to as the “ping rate”, which tells how many measurement observations are collected each second. The operating frequency of the echo-sounding means can be, for example, 400-700 kHz. The scanning frequency should be chosen in such a way that the distance of measurement observations from each other in the running direction is at most 30 cm, preferably less than 5 cm. The running speed and scanning frequency must be chosen so that a sufficient number of measurement observations are obtained from the target and object being scanned. If in the future the echo-sounding means scanning frequency can be raised, the running speed can also be raised. The precision demanded from the measurement in the end determines the scanning frequency required.

The determining of the position and attitude of the target is preferably performed simultaneously with the scanning. The determining of the position data should take place in such a way that the position data of the target are known at the same moment as the measurement observation is obtained. The target's position data need not necessarily be determined as frequently as measurement observations are obtained. For example, 60 measurement observations can be obtained per second and the target's position data can be determined 1-10 times per second. According to FIGS. 1a and 1b, the target 32 can include a GPS receiver, to which the satellite 39 sends time and position data, which can be later transferred to the apparatus's computer 40. Alternatively, an optical measurement device, for example, a tachymeter 41, can be used, according to FIG. 1c, which optically determines the distance and direction of the target 32 from the tachymeter 41 and can transmit, by a transmitter, data on its own position and the time in question by radio to the computer. Alternatively, the data can be recorded in the target and the final determining of the positioning data can be performed by post-calculation. The target's 32 position data are linked to each measurement observation taken at the same moment in time. The method according to the invention can also be implemented in such a way that a target floating in the vicinity of a floating object is positioned with the aid of a tachymeter, unlike in FIG. 1c. The attachment means of the floating target can be an anchor, by which the target is locked to the bottom of the waterway.

The arrangement also includes attitude-detection means 68, which are preferably an attitude sensor attached to the target 32 and, if necessary a gyro (compass). The attitude sensor preferably includes an acceleration sensor and an angle sensor. With the aid of the attitude-detection means, the target's tilt and its direction are advantageously ascertained. The target's underwater position data can be calculated exploiting information on the distance between the target's part above the water surface and that below it, the tilt of the target and the position data of the part above the water surface. Thus, for example, a momentary tilt of the target due to waves can be taken into account at each measurement observation. A gyro is not necessarily needed, but can act as a standby source, when the same data are obtained from several sources. In this way the mutual accuracy of the different sources can be compared and, in possible disturbances, another one can be used.

According to one embodiment, the acceleration sensor used as the attitude sensor can be a 3-axis acceleration sensor, which can be situated anywhere on the target, assuming that internal deformations do not take place in the target. In addition to an acceleration sensor, the attitude sensor can also include an angle sensor. With the aid of a 3-axis acceleration sensor the direction of the acceleration can be determined, whereas the magnitude of tilt is obtained with the aid of the angle sensor. An angle sensor will detect a change in angle of a magnitude of even 0.01°. The attitude can be determined at a frequency of 20-400 Hz, preferably 50-200 Hz. The frequency of determining the attitude defines how many times a second the attitude data of the target is determined. If the target moves much during measurement, for example in a rough sea, the attitude determining frequency should be great, because the position of the target changes continuously. The acceleration sensor mainly measures the attitude of the target, but in exceptional situations, for example, during breaks in GPS or similar, the attitude and position can be determined using parameters.

If the attitude of the target is determined optically with the aid of a tachymeter, determining can be performed in the following stages. First orientation takes place relative to the set of co-ordinates to be used in the measurement, with the aid of a tachymeter or similar optical device. The term set of coordinates of the measurement refers to a direction selected at the start of the measurement, which is defined relative to the x, y, and z axes. The co-ordinate and elevation system used in the satellite positioning of the tachymeter is selected from several existing systems. What is important is that the echo-sounding means and the target make their observations in the same order. Next the tachymeter or tachymeters to be used are selected and the distance between the target and each tachymeter is measured. As a partner for the tachymeter at least two prisms should be attached to the target, which the tachymeter monitors. The tachymeters' positioning data in the set of co-ordinates is defined with the aid of positioning. The anchor points of the set of co-ordinates are obtained from the tachymeter's positioning data. With the aid of the distances measured between the tachymeter and the prisms, the direction of the target (tilt/rotation) can be determined and with the aid of the positioning means the position data of the tachymeter in the set of co-ordinates and the orientation of the tachymeters is known. The target's attitude data obtained as a result of the measurement is time-stamped, preferably with the aid of a clock belonging to the attitude sensor or GPS-positioning device, simultaneously with the measurement.

The floating target 32 according to FIG. 1d tilts according to the waves and the difference between the positioning data of the part 33 of the target 32 above the water surface 12 and the part 33.3 below is d. Therefore the position data p1 determined on the basis of the part 33 of the target 32 above the water surface 12 do not correspond to the position data p2 of the part 33.1 below the water surface 12. Due to this, the position data p1 should be corrected using the attitude data, when the position data p2 can be determined precisely and correctly on the basis of the position data p1.

The attitude data can be determined either in real time or by post-calculation. Preferably, however, the determining takes place in real time. In real-time determining, the position data of the target are preferably determined at the moment of measurement, for example, with the aid of satellite positioning and the position data of the target obtained from the target, for example with the aid of echo-sounding means, are automatically compared with the position data measured at the same moment with the aid of satellite positioning. If everything takes place by post-calculation, it will then be sufficient for the position data of the echo-sounding means and target to be recorded, for example in the relevant intermediate memory, and retrieved and processed later.

The data from the echo-sounding means 36 can be transferred immediately wirelessly or along conductors to the computer 40, where at least one target 32 position datum, which is obtained from the positioning means 38 to which the computer 40 is connected, is attached to each measurement observation. Alternatively, the data transfer need not necessarily be in real time, instead it can be stored in the apparatuses and the final determining of the position data can take place by post-calculation. The position data contains at least one coordinate of the target, but preferably also attitude data and time data. In addition, the position of the echo-sounding means 36 at the moment of performing the measurement, and the orientation and rotational angle of the echo-sounding means 36 can also be attached to the measurement observation. The orientation of the echo-sounding means 36 at the moment of scanning can be determined on the basis of the route 30 of FIG. 2. In other words, in connection with scanning, the measurement observations can receive not only the target's position data but also an approximate location (co-ordinates+orientation), when they can be taken to the software means 42 situated in the computer 40.

The software means 42 can be arranged to combine the consecutive underwater measurement observations on the basis of the target's position data, in order to form the three-dimensional point cloud 20 of FIG. 4. The 3D point cloud can for formed by measuring the boat's sailing line and attitude at each moment in time. The individual measurement observations are placed along the sailing route and the angles are corrected using values according to the attitude sensors, from which the point cloud is formed. The target being measured appears in this point cloud. Even at this time, the entire sailing line and position of the target can be slightly incorrect. The definition of the position of the target, for example from the shore, will tell the real position of the target. One alternative is to move the measured sailing line, in which the target appears in such a way that the centre point of the target is at a more precisely defined point than previously. Another alternative is to change the boat's sailing line and in that way define a new position for the observation group, i.e. the point cloud collected during the entire sailing line. All of this can be done either in real time or later with the aid of post-calculation. The software means detect from the images the underwater part of the target and, on the basis of its positioning data the measurement observations are placed in the set of co-ordinates. Alternatively, the software means can place the measurement observations to form a point cloud in the set of co-ordinates also on the basis of the position calculated on the basis of the original position data of the scanning base, but then the measurement observations should be finally corrected by utilizing the target's position data and attitude data.

FIGS. 3a and 3b show two different embodiments of the target 32 of the arrangement according to the invention. The target 32 of the arrangement according to the invention includes, in all embodiments, a body 60, attachment means 62 joined to the body 60 for attaching the target 32 in place to be at least partly floating in the desired location in the vicinity of the object and target marks 64 and 66 preferably attached to the body 60. The term partly floating refers to the fact that the target is free to move in at least two directions. More specifically, the target 32 can include a target mark 64 below the water surface, for distinguishing the target 32 on the basis of acoustic measurement, and a target mark 66 above the water surface attached in connection with the body 60, for determining the precise position of the target 32 by means of optical measurement.

According to FIGS. 1a, 1c, and 2a, the target 32 can be attached to the object 10 to be scanned with the aid of the attachment means 62 of FIG. 3a. The target thus remains very firmly in place and can be implemented without an anchor. In this case, the attachment means 62 can be, for example, a shoe or similar support iron for attachment, by means of which the target is attached to the object in a pivoted manner. However, such an embodiment has the drawback of the attachment being formed between the target and the object to be scanned, which demands drilling or similar mechanical work to ensure the attachment. In addition there may be the problem of the target hiding part of the object to be scanned from view, in which case a hole the size of the target will remain in the measurement observations.

According to FIGS. 1b and 2b, in a second preferred embodiment the target 32 can be secured in the vicinity of the object 10 to be scanned, when the entire object to be scanned can be mapped with the aid of overlapping measurement observations. In such an embodiment according to FIG. 3b, the target's 32 attachment means 62 can be, for example, a cable 70 secured to the target 32 at one end, to the other end of which a weight 72 acting as an anchor is attached. With the aid of the attachment means 62, the target 32 can be made to remain more or less in place, which will prevent the target 32 from escaping outside the area being scanned.

The target mark 66 above the water surface can be, for example, in projection an A4-sized object, which can be easily detected by a tachymeter. The part 33 of the target 32 above the water surface 12 can be in length, for example 1-2 m, when it will be clearly distinguished above the water surface and can be easily lowered into the water from a boat, the shore, or a jetty 45 (FIG. 1c). The target's 32 target mark 64 under the water surface can, in turn, have a diameter of 0.1-1.0 m, preferably 0.4-0.7 m. The target mark 66 below the water surface is preferably shaped in such a way that it includes shaped target surface shapes 14, which facilitate the detection of the target from measurement observations according to FIGS. 5a and 5b. The surface of the target mark 64 below the water surface preferably comprises target surface shapes, which can be a corrugated surface or otherwise a shape that reflects a sufficient echo back to the echo-sounding means. The surface can be, for example, a pitted surface like that of a golf ball, as in FIG. 5a. Alternatively, the target mark 66 below the water surface can consist of several differently-sized target surface shapes 14, which vary in width, depth, and height, according to FIG. 5b. According to one embodiment, the target mark can be formed by the body of the target 32. The target mark of a tachymeter can also be a mirror prism, which can have a diameter of, for example, 0.5-5.0 cm.

According to one embodiment, the target mark can include separate orienting means that facilitate the determining of the orientation, which can be, for example, shaped target-surface shapes. The target-surface shapes can have a certain preselected orientation, on the basis of which the orientation of the target can be deduced.

According to one embodiment, the target's attitude-detection means can be optical measurement means, such as, for example, a tachymeter, by means of which the position of two or more overlapping identifiers attached to the part of the target above water can be measured continuously.

The method according to the invention can be used, for example, for scanning the bottoms of lakes, rivers, and seas, for inspecting the condition of bridge foundations, harbours, and jetties, and for many other suitable purposes. The method and target according to the invention can also be used for the underwater positioning of cave objects.

In this connection, it should be understood that, according to one embodiment the method according to the invention can also be used in such way that the position of a scanning unit above the water surface is determined with the aid of the target. In practice, this can be used, for example, with objects, in which definition of the position data produced by the scanning unit's satellite antennae is prevented. Such places can be, for instance, shadow areas, such as bridges, canyons, and caves. In such an embodiment, there can be, for example, a tachymeter and positioning means in the target, and a prism in the scanning unit. Thus, the scanning unit's position data can be defined with the aid of the target.

According to one embodiment, the arrangement according to the invention can also be used to ensure the accuracy of the scanning of an underwater object, in stages in which
the object to be scanned is equipped with at least one target, which includes both a part above the water surface and a part below the water surface and positioning means,
A floating scanning unit is equipped with echo-sounding means and with second positioning means,
the position data of the target's part above the water surface is determined,
the target's attitude data is determined time-dependently during the scanning,
the object is scanned from below the water surface using the echo-sounding technique, in order to create measurement observations,
the target is detected from the underwater measurement observations,
the position data of the part of the target below the water surface are determined from the echo-sounding's measurement observations,
the reference position data of the underwater part of the target are determined on the basis of the attitude data and the position data of the part of the target above the water surface, and
the reference position data and the position data of the underwater part are compared with each other to ensure accuracy.

By means of such a method, the accuracy of the scanning measurement observations and the positioning of the target can be ensured advantageously in real time.

1-14. (canceled)

15. Method for improving positioning accuracy of scanning of an underwater object, in which method
equipping the object to be scanned with at least one floating target, which includes both a part above surface of water and a part below the surface,
determining position data of the target on basis of the part of the target above the surface of the water,
determining target's attitude data time-dependently during the scanning,
determining initial position data of the part of the target below the surface of the water on the basis of the said position data of the target,
scanning the object to be scanned from under the surface of the water to create measurement observations,
detecting the target from said measurement observations under the surface of the water,
aligning the position data of the target from the measurement observations with identified target to improve the positioning accuracy of the scanning,
correcting alignment of the initial position data of the part of the target below the water surface with the measurement observations on the basis of the said attitude data.

16. Method according to claim 15, wherein target's position data is determined with aid of satellite positioning, using the part of the target above the water surface.

17. Method according to claim 15, wherein target's position data is determined optically with a tachymeter using the part of the target above the water surface.

18. Method according to claim 17, wherein a scanning unit is used for scanning, which includes echo-sounding means for performing the scanning, and determining the position data of the scanning unit with satellite positioning.

19. Method according to claim 15, wherein angle of tilt is determined as the said attitude data.

20. Method according to claim 19, wherein additionally direction of the tilt is determined as the said attitude data.

21. Method according to claim 15, wherein the attitude data is determined at a frequency that is 30-400 Hz

22. Method according to claim 15, wherein the attitude data is determined at a frequency that is 60-200 Hz.

23. Arrangement for the scanning of an object taking place from under surface of water, which arrangement comprises a floating target, positioning means for determining the target's position data and attitude-detection means for determining the target's attitude data time-dependently, the target comprising:
a body comprising a part under the water surface for distinguishing the target on basis of acoustic measurement and a part above the water surface for determining the target's precise position data,
securing means joined to the said body for securing the target in place in desired location in vicinity of the object.

24. Arrangement according to claim 23, wherein the said attitude-detection means are situated in the target, to detect the target's attitude, and memory means to attach the momentary attitude data to the time data.

25. Arrangement according to claim 23, wherein said body is arranged to float.

26. Arrangement according to claim 23, wherein the securing means is an anchor.

27. Arrangement according to claim 23, wherein the target includes a target mark below the water surface fitted to the part of the target below the water surface, to distinguish the target.

28. Arrangement according to claim 24, wherein the target includes a target mark above the water surface fitted to the part of the target above the water surface, to determine the target's precise position data,

29. Arrangement according to claim 28, wherein the said target mark below the water surface comprises shaped target-surface shapes to facilitate detection of the target mark below the water surface.
